(19) United States
(12) Patent Application Publication
(10) Pub. No.: US 2016/0179831 A1
(43) Pub. Date: Jun. 23, 2016

(54) SYSTEMS AND METHODS FOR TEXTUAL CONTENT CREATION FROM SOURCES OF AUDIO THAT CONTAIN SPEECH

(71) Applicant: VOCAVU SOLUTIONS LTD., Ramat Gan (IL)

(72) Inventors: Zeev Gruber, Ramat Gan (IL); Ziv Turner, Kfar Saba (IL); Nissim Atias, Raanana (IL); Eduard Polityko, Rehovot (IL)

(21) Appl. No.: 14/891,221

(22) PCT Filed: Jul. 14, 2014
(86) PCT No.: PCT/IB2014/002304

§ 371 Date: Nov. 13, 2015

Related U.S. Application Data
(60) Provisional application No. 61/846,214, filed on Jul. 15, 2013.

(51) Int. Cl. G06F 17/30; G06F 17/28; G10L 15/26; G10L 19/018; G10L 17/00

(52) U.S. Cl. CPC G06F 17/3089; G10L 19/018; G10L 17/005; G10L 15/265; G06F 17/2809

(57) ABSTRACT

A system and method of creating textual content from audio streams is present. The system can include a computing device configured to receive audio streams containing speech and identify the different speakers in the speech. The system breaks apart an audio stream into separate audio streams using speaker diarization and each audio stream is sent separately to a speech-to-text transcriber. Each audio stream includes only the speech of a single speaker, which is more easily converted into text by the speech-to-text transcriber. The text streams can be assembled into a transcript of the speech portions of the audio stream. A web page of the transcript can be published. High frequency words in the transcript can be tagged in the metadata of the web page to assist search engines and increase the value of the web page.

### REFERENCE TO RELATED APPLICATIONS

This PCT application claims priority to U.S. Provisional Patent Application No. 61/846,214 filed 15 Jul. 2013.

### TECHNICAL FIELD

Embodiments of the technology relate, in general, to creating text-based content from sources of audio containing speech, and in particular to systems and methods of converting spoken dialog in broadcast audio sources into edited text-based searchable web pages accessible over the Internet or using a database.

### SUMMARY

In an embodiment, a textual content creation system includes a computing device configured to receive an audio stream that includes speech content, identify a speaker of the speech content in the audio stream, and send one or multiple audio streams with speaker diarization to a speech-to-text transcriber. The one or multiple audio streams sent to the speech-to-text transcriber are audio streams with speaker diarization and each consists essentially of portions of the audio stream that include speech identified with a single speaker. The computing device of the textual content creation system is also configured to receive one or more text streams of transcribed text associated with each of the audio streams with speaker diarization, and to assemble the transcribed text into an ordered transcript of the speech content in the audio stream. The textual content creation system can include a speech-to-text server that can provide one or more speech-to-text transcribers. The textual content creation system can include capture devices configured to receive broadcasts, capture audio streams from the broadcasts, and send digital audio streams of the captured audio to the computing device of the textual content creation system. The capture devices can be configured to receive over-the-air radio broadcasts or radio broadcasts streaming over the Internet. The computing device of the textual content creation system can be configured to identifying audio segment in the audio stream that contain speech and tag the segments with a tag that identifies the speaker. The ordered transcript can be assembled based on the tag. The ordered transcript can identify the speakers and the text associated with the speaker. The computing device of the textual content creation system can determine the frequency of words in the transcribed text and organize the text into paragraphs and pages based on the word frequency. The computing device can also determine a high frequency word in the transcript and create a web page for the transcript that includes metadata that identifies, by timestamp, where the high frequency word is in the audio stream. The computing device can add timestamps for generating links to the high frequency word in the audio stream. The computing device can also be configured to create a web page that links to another web page based on the high frequency word or based on the source of the audio stream.

A computer-implemented method can include receiving an audio stream that has audio segments having speech in the audio, identifying who is the speaker in each of the audio segments that has speech, and processing the audio stream into separate audio streams with speaker diarization. Each of the separate audio streams with speaker diarization essentially only a subset of audio segments from a single speaker. The separate audio streams can be sent to one or multiple speech-to-text engines, which transcribe the audio streams into text streams, each of which is associated with the separate audio streams. The method further includes assembling a transcript from the transcribed text from each of the text streams. The method can include associating a tag that identifies a speaker in each of the audio segments or sub-portions. The processing operation and assembling operation can be based at least in part on the tag and the speaker information conveyed in the tag. The assembling operation can use the tag in identifying each speaker and associating the identity of the speaker with transcribed text that are associated with each of the speakers. The method can also include receiving a broadcast that include audio, and sending a digital audio stream that represents the received audio as the audio stream. The method can also include determining high frequency words in subset of the transcribed text and assembling or formatting the transcript into paragraphs based at least in part on the high frequency words. The method can also include determining high frequency words in all or a subset of the transcript and using the high frequency words in metadata of a created web page that includes the transcript. The method can link that web page to another web page on the Internet based in part on the high frequency word.

In an embodiment, a non-transitory computer readable medium having instructions stored thereon can be executed by one or more processors and cause the processors to receive a radio broadcast that include speech content, process the radio broadcast to remove substantially all of content that is not speech and create a first audio stream that consists essentially of speech content and that has portions without any audio content. The instructions further cause the processors to identify a first speaking individual in a first sub-portion of the first audio stream, and tag that portion with a first speaker identification tag and timestamps. The instructions further cause the processors to identify a second speaking individual in a second sub-portion of the first audio stream, and tag that portion with a second speaker identification tag and timestamps. The instructions further cause the processors to create a second and third audio stream, each of which has only the first and second sub-portions respectively, and send the second and third audio streams as separate steams to one or multiple speech-to-text servers. The instructions further cause the processors to receive a first and second text stream back from the speech-to-text servers, which are transcriptions of the second and third audio sub-portions. The instructions further cause the processors to create a transcript of the speech content based on the first and second text streams and the time stamps. The transcript identifies the first speaking individual with text from the first text stream, and the second speaking individual with text from the second text stream in the transcript. The instructions can further cause the processors to determine a distribution of high frequency words in the transcript and publish a web page that includes those words in the metadata. The organization of the test of the transcript on the web page can be based at least in part on the distribution of high frequency words. The instructions can further cause the processors to translate all or a subset of the high frequency words into a foreign language and include the translations in the metadata.

### BRIEF DESCRIPTION OF THE DRAWINGS

The present disclosure will be more readily understood from a detailed description of some example embodiments taken in conjunction with the following figures:

FIG. 1 depicts an example textual content creation system, according to one embodiment.

FIG. 2 depicts an example computing device, according to one embodiment.

FIG. 3 depicts example operations for creating textual content from audio sources containing speech elements, according to one embodiment.

### DETAILED DESCRIPTION

Various non-limiting embodiments of the present disclosure will now be described to provide an overall understanding of the principles of the structure, function, and use of textual content creation systems and methods disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

Described herein are example embodiments of computer-based systems and methods for converting speech contained in audio content into searchable text-based content. The disclosed subject matter includes specific examples directed to transforming radio audio broadcasts to web text, audio analysis for detecting if the person speaking has changed, speech and music separation, and multilingual tagging of audio content using text that was converted or transcribed from the audio content. The examples discussed herein are examples only and are provided to assist in the explanation of the apparatuses, devices, systems, methods, and processes described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

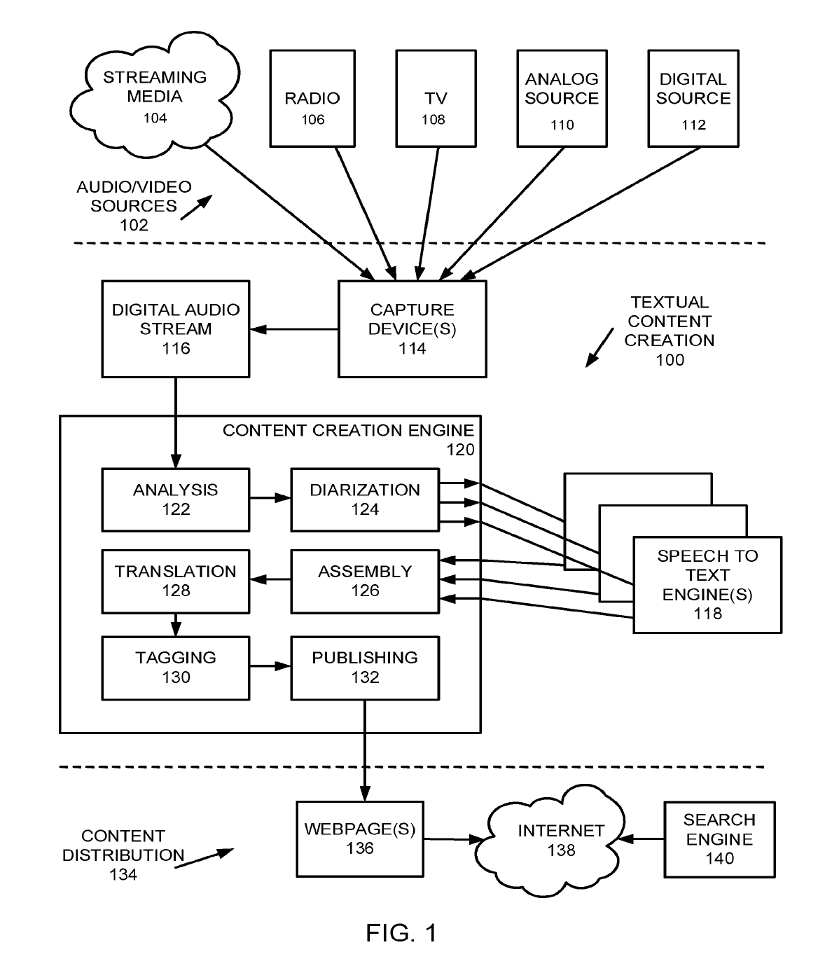

Referring to FIG. 1, an embodiment of a textual content creation system 100 can include one or more capture devices 114 for capturing and storing audio content from audio/video sources 102, a content creation engine 120, and one or more speech-to-text engines 118.

Audio/video sources 102 can include suitable sources of streaming media 104, for example media having dialog or other voice content that is streamed over the Internet 138. Example streaming media 104 can include Internet radio broadcasts, pod casts, streaming video having a soundtrack, YouTube™ clips, and so forth. Other audio/video sources 102 can include radio broadcasts 106 for example traditional analog over-the-air broadcasts or digital satellite, for example Sirius™ satellite, and television broadcasts 108 for example traditional analog broadcasts and analog cable channels digital HDTV broadcasts, satellite broadcasts such as Dish™ or DirectTV™, TIVO™ or other PVRs (personal video recorders), and so forth. Still other audio/video sources 102 can include analog sources 110 such as microphone outputs, and digital source 112 such as outputs from soundboards, and the like. Other suitable audio/video sources 102 as would be understood by one of ordinary skill in the art are also contemplated.

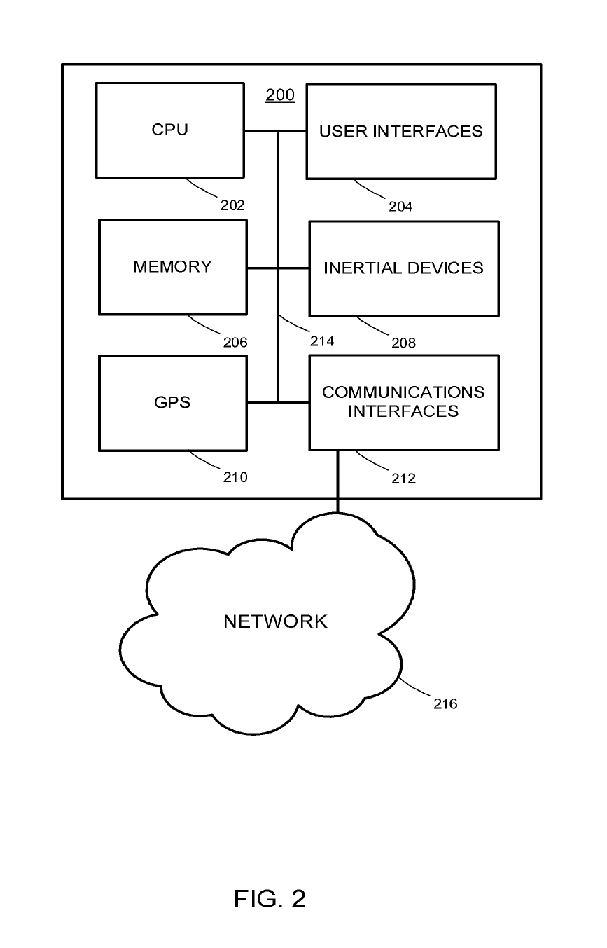

A capture device 114 can capture one or more audio streams, or audio/video streams, from various audio/video sources 102 and convert, as necessary, each stream into a digital audio stream 116 suitable for the content creation engine 120. Suitable digital audio streams 116 can be any proprietary or standards based audio stream. For example, a digital audio stream can be a 16, 32, 64, 128, 256-bit or higher uncompressed digital audio stream, or a lossless or lossy compressed audio streams such as MP3, and so forth. Suitable sampling frequencies such as 44.1 kHz, 48 kHz, 88.2 kHz, 96 kHz, and 176.4 kHz, among others, can be used. A capture device 114 can be a computing device as described below with respect to FIG. 2. For example, a capture device 114 can be a PC, Mac, Linux-based, or embedded computer having a radio application and/or over-the-air radio receiving hardware that is capable of capturing and encoding the audio from a selectable radio station or radio stations into the digital audio stream 116. In an embodiment, multiple capture devices with automated scripts can be utilized to capture thousands of radio stations simultaneously and generate tens to hundreds of thousands of web pages per hour.

The content creation engine 120 can receive the digital audio stream 116 from the capture device 114. In a configuration, the content creation engine 120 can directly receive a suitable digital audio stream 116 from an audio/video source 102 directly. In various configurations, the capture device 114 can be part of the content creation engine 120, reside in a common hardware platform with the content creation engine 120, be physically connected to the content creation engine 120, or be networked to the content creation engine 120 over a suitable wired or wireless communications network and/or use a suitable data link and communications protocol for transmission of the audio or audio/video content over the network using, for example, a suitable Internet Protocol (IP).

The content creation engine 120 can be a computing device as described below with respect to FIG. 2. For example, the content creation engine 120 can be a PC, Mac, Linux-based, or embedded computer that includes one or multiple processing units, such as central processing units and/or graphics processing units, that execute instructions stored in memory to perform the processes described herein.

The content creation engine 120 is illustrated, in FIG. 1, as a single system for convenience, however in practice the operations performed by content creation engine 120 can be performed by a common server or servers, or executed across multiple servers as would be understood in the art. The content creation engine 120 is illustrated as having several modules 122, 124, 126, 128, 130, 132. However, in practice, modules can be further subdivided or joined together as would be understood in the art. Each module can execute computer instructions to perform one or more functions. The computer instructions can be executable code, scripts, or other machine instructions as is known in the art. The computer instructions can be stored in a computer-readable medium or loaded onto the content creation engine 120 to cause the operations described herein to be performed.

The content creation engine 120 can be configured to receive digital audio streams 116 from one or multiple capture devices 114 concurrently. When a digital audio stream 116 is received by the content creation engine it can be processed by an analysis module 122. The analysis module 122 can perform audio analysis which can include algorithms to remove noise, detect pauses or breaks between audio segments and speech, identify non-dialog segments such as music or singing, identify voice patterns, and so forth. For example, the analysis module 122 can be enhanced with filtering algorithms to remove noise such as background noise, undecipherable audio, background music, and street level noises such as wind, car sounds, or crowd noises such as cheering. In a configuration, the analysis module 122 can filter the raw audio stream of the digital audio stream 116 to produce a clean audio stream. In a configuration, the analysis module 122 can tag sub-portions of the digital audio stream 116 to indicate which sub-portions are to be ignored and which sub-portions are to be converted to text.

The analysis module 122 can detect pauses, for example pauses between segments or a pause that naturally occur in regular speech patterns between words. For example, the analysis module 122 can detect whether a pause is longer than a predetermined period of time, such as 300 msec, that would indicate or suggest that the detected pause is not the normal ordinary pauses that occurs between words when a person is speaking.

The analysis module 122 can identify known pre-existing audio content in the digital audio stream 116. For example, the analysis module can identify tones, music, songs, commercials, and the like. In an embodiment, the analysis module 122 can communicate with a third party source to identify certain pre-existing content. For example, a third party source may have a library of thousands of songs and be able to identify whether a segment of audio content has be sampled from one of those songs. In this configuration, the analysis module 122 can use an algorithm, such as MD5, to create one or more hash values that are sent to the third party to identify whether a segment of the digital audio stream 116 matches any known pre-existing content. The analysis module 122 can tag or mark a segment of the digital audio stream 116 not to be further analyzed or converted to text by the content creation engine 120. This feature can be configured to avoid copyright or other IP issues, to avoid duplicative processing because that content is already available in another media form, to prevent uninteresting or duplicative content from being added to the text content that is created by the content creation engine 120, and for other suitable reasons.

The analysis module 122 can identify the pattern of speakers, for example multiple speakers during dialog. The analysis module 122 can identify and differentiate each speaker during a conversation. The analysis module 122 can detect whether two speakers are talking at the same time or if any overlapping has occurred between speakers or between a speaker and another sounds element, such as music or other audio content. The analysis module 122 can detect a change between speakers during a dialog or conversation. The analysis module 122 can be enhanced with a tonal change detection algorithm that can assist in identifying speakers for radio broadcasts and other audio/video sources 102 where speakers speak simultaneously which can otherwise cause the assembled text transcript to become unintelligible. Tonal change detection can be based on (a) speech mode, such as polite conversation or single speaker, (b) speech style, such as a read speech, an oral story, a performance on a given topic, or spontaneous conversion, (c) format, such as lossless, compressed, lossy, (d) sampling frequency, (e) SNR or signal-to-noise ratio, (f) frame duration, (g) type of window, such as Kaiser, Hamming, and so forth, (i) window duration, and (j) window shift, among other distinctions.

The analysis module 122 can be enhanced with an algorithm that can identify a speaker by voice signature from a database or data store of voice signatures. For example, celebrities, radio broadcasters, and even ordinary individuals can be identified by distinctive qualities of their voice. The identity of a speaker can be stored and associated with a speaker identification tag that is used to identify the speaker in a segment or sub-portion of audio. In a configuration, the identity of the speaker is used in the speaker identification tag. The analysis module 122 can attribute certain segments or sub-portions of the digital audio stream 116 to a particular speaker based on voice signatures.

The analysis module 122 can identify within the digital audio stream 116 individual audio segments or sub-portions of the digital audio stream 116, to be identified with particular speaker. Each segment or sub-portion can be time stamped and tagged to associate it with a particular speaker, for example using the speaker identifier tag. In a configuration, the analysis module 122 can break apart the audio segments or sub-portions of the digital audio stream 116 based on the identified speaker. In a configuration the diarization module 124 performs the operation of breaking apart the digital audio stream 116 into sub-portions or segments. In an embodiment, the analysis module 122 and diarization module 124 can be a single module.

In a configuration, the analysis module 122 can assign more than one speaker identifier tag to overlapping portions that are identified as having more than one speaker speaking at the same time. The analysis module 122 can also include one or more timestamps. For example, at the beginning of each segment or sub-portion of audio, a tag indicating the speaker and a timestamp can be added. In another example, the segment or sub-portion can include a start timestamp and an end timestamp. In various configurations, the tags or timestamps can be stored with digital audio stream 116, in the digital audio stream 116, and separate from the digital audio stream 116 to accomplish similar results as would be understood by one of ordinary skill in the art.

The sub-portions or segments can be of any suitable length. For example, as a person is speaking continuously, a segment can be identified, time stamped and tagged to be associated with that speaker. If the person stops speaking, pauses, or is interrupted by another speaker, the end of the segment can be identified. A pause can be used as a cut-point and identify the end of a segment even if the speaker has not changed. A new sub-portion or segment can then be tagged. In a configuration, pauses that are tagged or otherwise identified can be used to identify paragraph breaks in the text when a text stream is being assembled into sentences and paragraphs in the text transcript by the assembly module 126.

By identifying a single speaker in each segment or sub-portion, certain advantages can be realized. In the embodiment illustrated in FIG. 1, the diarization module 124 breaks the digital audio stream 116 into separate audio streams for processing by the speech-to-text engines 118. The diarization module 124 also can use a separate, dedicated audio channel for each speaker to the speech-to-text engine 118. In this configuration, the voice from only one speaker is sent in each audio stream to the speech-to-text engine 118 using one channel. Other speakers' audio streams can be sent in their own individual channels. Keeping speakers in separate audio streams can advantageously improve the quality of the speech-to-text operation of the speech-to-text engines 118. The diarization module 124 can use the tags and timestamps to break the digital audio stream 116 into segments or sub-portions of audio, and direct each to the speech-to-text engine as a separate stream of audio, for example using a different channel based on the speaker. In a configuration, a common communication channel or data link can be configured between the diarization module 124 and the speech-to-text engine 118 and the streams of audio can be kept separated logically.

The speech-to-text engine 118 can analyze each audio stream that contains speech and produce text corresponding to that speech. Automatic Speech Recognition (ASR) technology can be used as the speech-to-text engine 118. In a configuration, the speech-to-text capability is provided by a third party, for example by a product such as Nuance Dragon™ from Nuance™ executing on a server. In a configuration, a separate speech-to-text engine 118 is used for each stream of audio. In a configuration, a common speech-to-text engine 118 can execute multiple instances, threads, processes, or the equivalent to keep the streams of audio logically separate. In a configuration, the speech-to-text engine 118 can be a cloud service or the operation can be spread among multiple servers. In an embodiment, the speech-to-text engine 118 can be a third-party product or service, for example using one of the Nuance™ line of products for transcribing text from speech. Example communications and messaging between the speech-to-text engine 118 and the content creation engine 120 can include using any suitable IP-based protocol, sockets, secure sockets, and so forth. In an embodiment, the speech-to-text engine 118 can be part of the content creation engine 120.

Each audio stream can be translated by a speech-to-text engine 118 using a different dictionary that can be based on the type of content being translated. For example, a particular type of radio show or a particular host or set of participants can used a dictionary best suited for translating the speakers. By keeping each audio segment or sub-portion short, certain other advantages also can be realized. For each segment or sub-portion, different dictionaries may be used. For example, as conversation topics change, as frequently occurs during talk radio broadcasts, the speech-to-text engine 118 can employ different dictionaries. For example, based on the conversation, the speech-to-text engine 118 can select specialized or professional dictionaries to assist with translation. For example, a medical dictionary with terms based on the Latin vocabulary can be used. The speech-to-text engine or the content creation engine 120 can use various methods to determine which dictionary to use, including, without limitation, identifying keywords in the transcript text, the error rate of the text from the speech-to-text engine 118. In a configuration, a sub-portion can be re-sent through the speech-to-text engine 118 and one or more dictionaries can be employed to improve the results.

The content creation engine 120 can use keyword spotting to improve transcription by the speech-to-text engine 118. For example, the speech-to-text engine 118 can use a general dictionary by default and then switch, or be switched to, a professional sub-dictionary by a keyword spotting mechanism. In a configuration, the keyword spotting mechanism and methodology can be employed to identify a keyword in an audio stream prior to translation and transcription by the speech-to-text engine 118, for example by using hidden Markov models, isolated word recognition, and acoustic modules in the analysis module 122 or any other suitable part of the content creation engine 120 or speech-to-text engine 118.

Each speech-to-text engine 118 can send a stream of text to the content creation engine 120 for the particular audio stream the speech-to-text engine 118 transcribed. An assembly module 126 in the content creation engine 120 uses timestamps, and tags such as the speaker identification tag to match the transcribed text with the particular speaker and compose text that corresponds to the audio content. In a configuration, the assembly module 126 can use timestamps associated with each segment or sub-portion to assemble the various stream of received text back in the correct order to create an ordered text transcript. In a configuration, the text in the streams of text is received by the assembly module 126 in the same order in which it was spoken. The assembly module 126 reconstructs the dialog or conversation in text by matching the tags associated with the digital audio stream 116 with the streams of text to create the assembled text of the text transcript. The assembly module 126 can include an identifying speaker indicator, or text ID, that is associated with the speaker identification tag to identify which text is associated with which speaker. For example, to distinguish several unknown speakers, text IDs such as “speaker 1”, “speaker 2”, and so forth can be used. In a configuration, when the identity of the speaker if known, the assembly module 126 identifies the text using the identity of the speaker. In a configuration, the assembly module 126 can identify two streams of text as belonging to a common speaker, for example based on context derived from the transcribed text.

In a configuration, the assembly module 126 can edit the received streams of text into a format more suitable for reading by a person. For example, the assembly module 126 can reconstruct clauses, sentences and paragraphs from the received streams of text from the speech-to-text engine 118 into an ordered text transcript. For example, the assembly module 126 can use clauses of 50-80 words total, or another suitable configuration parameter, as the default length of a paragraph in the text transcript. In another configuration, linguistic rules can be applied to mimic the sentence structure an Internet article or a post. For example, rules can be applied to generate clauses based on differentiation between speakers and/or the number of words per paragraph. A top predetermined number, N, of repeating words (excluding moderating words and parts of speech such as articles) per paragraph may tagged as discussed below. That list may be compared to the previous paragraph top N words to determine if a topic or subject change has occurred in the dialog between speakers. For example, a change in the number of use of each of the top N words that is greater than a configurable threshold, such as 50%, can be indicative of a change in the subject or topic of conversation. In another example, if more than 60% of the top N words themselves change, that could indicate a change in the subject or topic of conversation. In another example, if the top N words change and 75% of the top N words are then consistent in later paragraphs, it could indicate a change in the subject or topic of conversation. These and other suitable rules can be used to break streams of text into more presentable paragraphs and pages for the reader. For example, if there is a single speaker who is giving a lecture, the assembly module 126 can use these and other suitable rules to break the stream of text into paragraphs to aid the reader in better understanding the topics of the lecture. In other example, the rules can not only provide automatic separate of paragraphs and pages, but also include the creation of headlines and sub-headlines based on the detected subject or topic.

A translation module 128 can translate the assembled text into selected languages. In an embodiment, the translation module 128 and tagging module 130 can be the same module.

A tagging module 130 can analyze the text or assembled text to determine the most common words in each clause or paragraph. Using word frequency, or other suitable algorithms, the tagging module 130 can determine the most common words. Conjunctive terms, articles, and other common moderating words or parts of speech such as “and”, “or”, “but”, “so”, “a”, “an”, “the”, “he”, “she”, and the like can be excluded from the list of top words appearing the assembled text. For example, the top three to five words appearing in the assembled text for each clause or paragraph can be stored in a tag with timestamps. The top words can be used to create metadata in a web page 136, for example to increase the value of the value of the web page 136 and improve the ranking of the web page 136 by search engines 140. The timestamps can enable fast searching within an audio file, if one is linked to the web page 136. The metadata can be searched by search engines 140 such as Google™ when the web page 136 is published to the Internet 138. The most common words per clause or paragraph can be used to link the web page 136 to other web pages that have similar words and topics.

In an embodiment, the tagging module 130 can add additional terms based on statistical wording relationships, historical data, and so forth. For example, five to eight words related to the most common word can be determined. If the most common word is “pizza”, then tagging module 130 can add the following associated words to a tag or metadata: “cheese”, “tomato”, “sauce”, “dough”, “bread”, “dairy”, and “fast food”. Other examples and configurations as would be apparent to one of ordinary skill in the art are also contemplated.

The translation module 128 can use dictionaries and other resources to translate the most common repeating words to other languages and add them to the metadata of the web page 136 so that users in other countries can search for, and find, the web page 136 using their native language. In this way, the most common words can be translated into Spanish, French, German, etc. and the metadata functions as a multilingual tag so that users can search for content in their native language.

A publishing module 132 can publish all or part of the text transcript as web pages 136 on various websites on the Internet. The publishing module 132 can format the text transcript into a web page 136 based on configurable rules. For example, a web page 136 can be limited to 300 words per page with paragraphs as describe above. In a configuration, the publishing module 132 publishes web pages on websites based at least in part on having the same or similar tags as the metadata. In an embodiment, the publishing module 132 can publish a web page 136 associated with a particular audio/video source 102 or program of an audio/video source 102. In an embodiment, the publishing module 132 can publish the web pages 136 on designated web sites or based on configurable rules.

Content distribution 134 can include having the web page 136 published on a publicly accessible server (not shown) on the Internet 138 and granting a designated search engine 140 access to the metadata and textual content of the web page 136. For example, a search engine 140 such as Google™ radio can be granted access, enabling Google™ radio to use the content of the web pages 136 to mimic searches of radio broadcasts. Users could then search on Google™ radio for textual content associated with a particular audio/video source 102 or program of an audio/video source 102 and have Google™ radio present snippets of matching content found using a textual search.

Content distribution 134 can also include linking the web page 136 to the audio/video source 102, for example by linking to an online version of the audio content, if available. In an embodiment, audio content can be quickly searched for commonly used words which can be found in the metadata of web page 136. The words in the audio content can be quickly accessed through links associated with timestamps for those words present in the online audio content. Content distribution 134 can also include making the textual content accessible through a database (not shown) or any other suitable form of inventory system including existing or future types of systems and services.

Referring now to FIG. 2, an example computing device 200 is presented. The processes described herein can be performed on or between one or more computing devices 200. A computing device 200 can be a server, a computing device that is integrated with other systems or subsystems, a mobile computing device, a cloud-based computing capability, and so forth. For example, the computing device 200 depicted in FIG. 2 can be the content creation engine 120, a capture device 114, and the computer platform that executes the speech-to-text engines 118. The computing device 200 can be any suitable computing device as would be understood in the art, including without limitation, a custom chip, an embedded processing device, a tablet computing device, a personal data assistant (PDA), a desktop, a laptop, a microcomputer, a minicomputer, a server, a mainframe, or any other suitable programmable device. In various embodiments disclosed herein, a single component can be replaced by multiple components and multiple components can be replaced by a single component to perform a given function or functions. Except where such substitution would not be operative, such substitution is within the intended scope of the embodiments.

Each computing device 200 includes one or more processors 202 that can be any suitable type of processing unit, for example a general purpose central processing unit (CPU), a reduced instruction set computer (RISC), a processor that has a pipeline or multiple processing capability including having multiple cores, a complex instruction set computer (CISC), a digital signal processor (DSP), an application specific integrated circuits (ASIC), a programmable logic devices (PLD), and a field programmable gate array (FPGA), among others. The computing resources can also include distributed computing devices, cloud computing resources, and virtual computing resources in general.

The computing device 200 also includes one or more memories 206, for example read only memory (ROM), random access memory (RAM), cache memory associated with the processor 202, or other memories such as dynamic RAM (DRAM), static ram (SRAM), programmable ROM (PROM), electrically erasable PROM (EEPROM), flash memory, a removable memory card or disk, a solid state drive, and so forth. The computing device 200 also includes storage media such as a storage device that can be configured to have multiple modules, such as magnetic disk drives, floppy drives, tape drives, hard drives, optical drives and media, magneto-optical drives and media, compact disk drives, Compact Disk Read Only Memory (CD-ROM), Compact Disk Recordable (CD-R), Compact Disk Rewriteable (CD-RW), a suitable type of Digital Versatile Disk (DVD) or Blu-Ray™ disk, and so forth. Storage media such as flash drives, solid state hard drives, redundant array of individual disks (RAID), virtual drives, networked drives and other memory means including storage media on the processor 202, or memories 206 are also contemplated as storage devices. It can be appreciated that such memory can be internal or external with respect to operation of the disclosed embodiments. It can be appreciated that certain portions of the processes described herein can be performed using instructions stored on a computer-readable medium or media that direct a computer system to perform the process steps. Non-transitory computer-readable media, as used herein, comprises all computer-readable media except for transitory, propagating signals.

Network and communication interfaces 212 can be configured to transmit to, or receive data from, other computing devices 200 across a network 216. The network and communication interfaces 212 can be an Ethernet interface, a radio interface, a Universal Serial Bus (USB) interface, or any other suitable communications interface and can include receivers, transmitter, and transceivers. For purposes of clarity, a transceiver can be referred to as a receiver or a transmitter when referring to only the input or only the output functionality of the transceiver. Example communication interfaces 212 can include wired data transmission links such as Ethernet and TCP/IP. The communication interfaces 212 can include wireless protocols for interfacing with private or public networks 216. For example, the network and communication interfaces 212 and protocols can include interfaces for communicating with private wireless networks 216 such as a WiFi network, one of the IEEE 802.11x family of networks, or another suitable wireless network. The network and communication interfaces 212 can include interfaces and protocols for communicating with public wireless networks 216, using for example wireless protocols used by cellular network providers, including Code Division Multiple Access (CDMA) and Global System for Mobile Communications (GSM). A computing device 200 can use network and communication interfaces 212 to communicate with hardware modules such as a database or data store, or one or more servers or other networked computing resources. Data can be encrypted or protected from unauthorized access, for example by using secure sockets, virtual private networks, and so forth.

Mobile computing devices can include inertial components 208 and global positioning systems components (GPS components 210). The inertial components 208 and GPS components 210 can determine the terrestrial position of the mobile computing devices. Mobile computing devices can use the inertial components 208 and GPS components 210 in combination with radio transmissions received via the network and communication interfaces 212 to accurately determine the position of a mobile computing device. The position can be transmitted to other computing systems.

In various configurations, the computing device 200 can include a system bus 214 for interconnecting the various components of the computing device 200, or the computing device 200 can be integrated into one or more chips such as programmable logic device or application specific integrated circuit (ASIC). The system bus 214 can include a memory controller, a local bus, or a peripheral bus for supporting input and output devices 204, and communication interfaces 212. Example input and output devices 204 include keyboards, keypads, gesture or graphical input devices, motion input devices, touchscreen interfaces, one or more displays, audio units, voice recognition units, vibratory devices, computer mice, and any other suitable user interface.

The processor 202 and memory 206 can include nonvolatile memory for storing computer-readable instructions, data, data structures, program modules, code, microcode, and other software components for storing the computer-readable instructions in non-transitory computer-readable mediums in connection with the other hardware components for carrying out the methodologies described herein. Software components can include source code, compiled code, interpreted code, executable code, static code, dynamic code, encrypted code, or any other suitable type of code or computer instructions implemented using any suitable high-level, low-level, object-oriented, visual, compiled, or interpreted programming language.

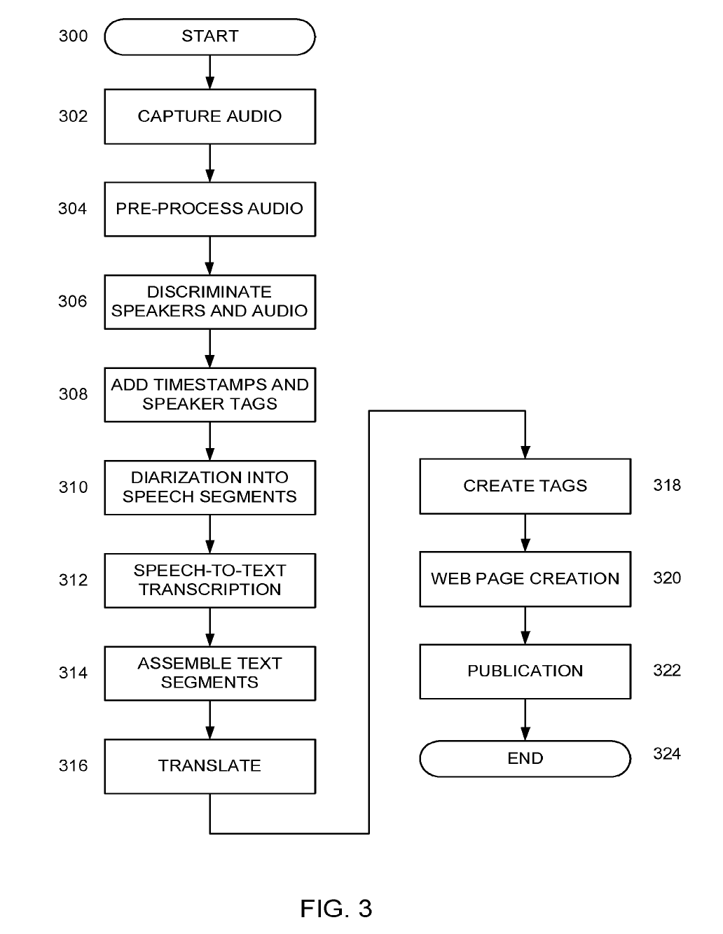

Referring now to FIG. 3, an example flow diagram of a textual content creation system 100 is presented. Processing starts at start block 300 and continues to process block 302.

In process block 302, a capture device 114 captures audio from an audio source, for example a radio broadcast 106 and converts it into a digital audio stream 116. Processing continues to process block 304.

In process block 304, the textual content creation system 100 can optionally pre-process the digital audio stream 116. For example, the raw audio stream from the radio broadcast 106 can be pre-processed or filtered to remove noise, background audio, and so forth as described above. In a configuration, all audio content that is not speech can be removed. The pre-processing and filtering produces a clean audio stream. Processing continues to process block 306.

In process block 306, the audio stream is analyzed. The textual content creation system 100 discriminates between different speakers and identified sub-portions or segments of the audio stream where a particular speaker is speaking. In a configuration, the textual content creation system 100 can identify the identity of the speaker. In a configuration, the textual content creation system 100 can distinguish between voice and other kinds of audio content. In a configuration, the textual content creation system 100 can identify pre-existing content. Processing continues to process block 308.

In process block 308, the textual content creation system 100 can add one or more speaker identification tags and one or more timestamps to the digital audio stream 116 to identify audio segments or sub-portions of the digital audio stream 116 where a speaker was identified as speaking in process block 306. Processing continues to process block 310.

In process block 310, the textual content creation system 100 uses the tags and speaker identification tags to send audio segments or sub-portions to different speech-to-text processes. In a configuration, each audio segment that includes a speaker identification tag of a speaker is sent to a speech-to-text process dedicated to that particular speaker. Processing continues to process block 312.

In process block 312, a speech-to-text process transcribes a received audio stream into text. In a configuration, a separate speech-to-text process is used for each speaker. Any suitable ASR, or Automatic Speech Recognition technology can be used. In a configuration, the speech-to-text capability is provided by a third party, for example by a product such as Nuance Dragon™ from Nuance™ executing on a server. Each stream of text associated with a separate speech-to-text process is sent to the assembly module 126 of the textual content creation system 100. Processing continues to process block 314.

In process block 314, each stream of text from each speech-to-text process is received by the assembly module 126 of the textual content creation system 100. In a configuration, each stream of text is received in the order that it was spoken in the digital audio stream 116. In a configuration, the assembly module 126 uses timestamps associated with each segment or sub-portion to assemble the text in the correct order. Words, phrases, sentences, and paragraphs can be identified with indicia such as the timestamp, an identifying indicator of the speaker, or the identity of the speaker if known. Processing continues to process block 316.

In process block 316, a translation module 128 of the textual content creation system 100 can optionally translate the assembled text into a desired language or languages. Processing continues to process block 318.

In process block 318, a smart tagging module 130 of the textual content creation system 100 can create smart tags, metadata, links, and other data based on keywords or any other suitable data in the assembled text or information associated with the text. Processing continues to process block 320.

In process block 320, a publication module 132 of the textual content creation system 100 can create a web page 136 based on any suitable combination of the assembled text, the text transcript, tags, and metadata. For example, the publication module 132 can include metadata in the web page 136 to increase the value of the web page 136 and improve the ranking of the web page 136 by search engines 140. Processing continues to process block 322

In process block 322, the textual content creation system 100 can publish the web page 136, for example by making the web page 136 available on the Internet 138. The web page 136 can be linked to other web pages. The web page 136 can be published in a way that makes the web page 136 available to a web crawler of a search engine 140 such as Google™.

In general, it will be apparent to one of ordinary skill in the art that at least some of the embodiments described herein can be implemented in many different embodiments of software, firmware, and/or hardware. The software and firmware code can be executed by a processor or any other similar computing device. The software code or specialized control hardware that can be used to implement embodiments is not limiting. For example, embodiments described herein can be implemented in computer software using any suitable computer software language type, using, for example, conventional or object-oriented techniques. Such software can be stored on any type of suitable computer-readable medium or media, such as, for example, a magnetic or optical storage medium. The operation and behavior of the embodiments can be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the processes described herein can be executed by programmable equipment, such as computers or computer systems and/or processors. Software that can cause programmable equipment to execute processes can be stored in any storage device, such as, for example, a computer system (nonvolatile) memory, an optical disk, magnetic tape, or magnetic disk. Furthermore, at least some of the processes can be programmed when the computer system is manufactured or stored on various types of computer-readable media.

It can also be appreciated that certain portions of the processes described herein can be performed using instructions stored on a computer-readable medium or media that direct a computer system to perform the process steps. A computer-readable medium can include, for example, memory devices such as diskettes, compact discs (CDs), digital versatile discs (DVDs), optical disk drives, or hard disk drives. A computer-readable medium can also include memory storage that is physical, virtual, permanent, temporary, semi-permanent, and/or semi-temporary.

A “computer,” “computer system,” “host,” “server,” or “processor” can be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein can include memory for storing certain software modules used in obtaining, processing, and communicating information. It can be appreciated that such memory can be internal or external with respect to operation of the disclosed embodiments.

In various embodiments disclosed herein, a single component can be replaced by multiple components and multiple components can be replaced by a single component to perform a given function or functions. Except where such substitution would not be operative, such substitution is within the intended scope of the embodiments. The computer systems can comprise one or more processors in communication with memory (e.g., RAM or ROM) via one or more data buses. The data buses can carry electrical signals between the processor(s) and the memory. The processor and the memory can comprise electrical circuits that conduct electrical current. Charge states of various components of the circuits, such as solid state transistors of the processor(s) and/or memory circuit(s), can change during operation of the circuits.

Some of the figures can include a flow diagram. Although such figures can include a particular logic flow, it can be appreciated that the logic flow merely provides an exemplary implementation of the general functionality. Further, the logic flow does not necessarily have to be executed in the order presented unless otherwise indicated. In addition, the logic flow can be implemented by a hardware element, a software element executed by a computer, a firmware element embedded in hardware, or any combination thereof.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

What is claimed is:

1. A textual content creation system, comprising:
a computing device configured to
receive an audio stream that includes speech from at least a first speaker and a second speaker,
identify a first portion of the audio stream having speech from the first speaker as a first portion of the audio stream with speaker diarization, and a second portion of the audio stream having speech from the second speaker as a second portion of the audio stream with speaker diarization,
send each of the portions of the audio stream with speaker diarization to a speech-to-text transcriber separate from the other portion of the audio stream with speaker diarization, each portion of the audio stream with speaker diarization consisting essentially of a portion of the audio stream that includes speech identified with exactly one of the first speaker or the second speaker,
receive one or more text streams, each text stream consisting essentially of a transcribed text of the speech of an associated portion of the audio stream with speaker diarization, and
assemble, from one or more transcribed texts, an ordered transcript of the speech of the audio stream.

2. The textual content creation system of claim 1, further comprising:
a speech-to-text server that includes at least two speech-to-text transcribers.

3. The textual content creation system of claim 1, further comprising:
one or more capture devices configured to
receive a broadcast,
capture at least an audio stream from the broadcast, and
send a digital audio stream representative of the audio stream to the computing device of the textual content creation system.

4. The textual content creation system of claim 3, wherein the broadcast is a broadcast streaming over the Internet, and wherein the capture device is configured to receive the broadcast streaming over the Internet.

5. The textual content creation system of claim 1, wherein the computing device is further configured to
identify a plurality of audio segments in the audio stream that contain speech, and
associate a tag that identifies at least one speaker with each of the plurality of segments of speech, and
wherein the ordered transcript is assembled based at least in part on the tag.

6. The textual content creation system of claim 1, wherein the ordered transcript further includes one or more indicators that identify each speaker of the transcribed text.

7. The textual content creation system of claim 1, wherein the computing device is further configured to
determine a frequency of one or more words in the transcribed text, and
organize the transcribed text into paragraphs based at least in part on the frequency of the one or more words.

8. The textual content creation system of claim 1, wherein the computing device is further configured to
determine a high frequency word in a least a portion of the ordered transcript, and
create a web page that includes
the ordered transcript, and
metadata that includes a plurality of timestamps of the high frequency word in the audio stream.

9. The textual content creation system of claim 8, wherein the web page includes a link to the audio stream that uses a timestamp of the high frequency word.

10. The textual content creation system of claim 1, wherein the computing device is further configured to
create a web page that includes
the ordered transcript, and
metadata that includes at least a word having a high frequency in the ordered transcript, and
link the web page to another web page based at least in part on either the metadata or a source of the audio stream.

11. A computer-implemented method, comprising:
receiving an audio stream that includes a plurality of audio segments that include speech of two or more speakers;
identifying at least one speaker of the speech in each of the audio segments;
processing the audio stream into a plurality of audio streams with speaker diarization, each audio stream with speaker diarization consisting essentially of a subset of audio segments, from the audio stream, that are identified with exactly one speaker;
sending each of the plurality of audio streams with speaker diarization to a separate speech-to-text engine;
receiving a plurality of text streams, each text stream consisting essentially of a transcribed text of the speech in an associated audio stream with speaker diarization;
assembling, from each of the transcribed texts, a transcript of the speech in the audio stream.

12. The computer-implemented method of claim 11, further comprising:
associating a tag that identifies the speaker with each of the plurality of segments of speech; and
wherein the operations of processing and assembling are each based at least in part on the tag.

13. The computer-implemented method of claim 12, wherein the assembling operation further comprises:
associating one or more indicators with the transcribed texts that identify each speaker with the transcribed texts.

14. The computer-implemented method of claim 11, further comprising:
receiving a broadcast that includes at least audio; and
sending a digital audio stream representative of the audio as the audio stream.

15. The computer-implemented method of claim 11, further comprising:
determining a high frequency word in at least a subset of the transcribed texts, and
wherein assembling the transcript further comprises organizing the transcribed text into paragraphs based at least in part on the high frequency word.

16. The computer-implemented method of claim 11, further comprising:
determining a high frequency word in at least a subset of the transcript; and
creating a web page that includes
the transcript, and
metadata that includes the high frequency word.

17. The computer-implemented method of claim 16, further comprising:
linking the web page to another web page based at least in part on the high frequency word.

18. A non-transitory computer readable medium having instructions stored thereon that when executed by one or more processors cause the processors to:
receive a broadcast that includes speech content;
process the broadcast to remove a substantial majority of non-speech content to create a first audio stream consisting essentially of portions of the broadcast having speech content;
identify a first speaking individual in one or more first sub-portions of the first audio stream;
tag the one or more first sub-portions with a first speaker identification tag and one or more associated time stamps;
identify a second speaking individual in one or more second sub-portions of the first audio stream;
tag the one or more second sub-portions with a second speaker identification tag and one or more associated time stamps;
create a second audio stream that consists essentially of the one or more first sub-portions;
create a third audio stream that consists essentially of the one or more second sub-portions;
send the second audio stream and third audio stream as separate streams to one or more speech-to-text servers;
receive a first text stream and a second text stream from the one or more speech-to-text servers, where the first text stream is a transcription of the second audio stream and the second text stream is a transcription of the third audio stream;
create a transcript of the speech content based at least in part on the first text stream, the second text stream, and the time stamps, and
wherein the transcript identifies the first speaking individual with text from the first text stream and the second speaking individual with text from the second text stream.

19. The non-transitory computer readable medium of claim 18, wherein the instructions further cause the processors to:
determine a distribution of high frequency words in the transcript; and
publish a web page that includes at least a subset of the high frequency words in metadata, wherein the organization of the text of the transcript on the web page is based at least in part on the distribution of high frequency words.

20. The non-transitory computer readable medium of claim 19, wherein the instructions further cause the processors to:
translate at least a subset of the high frequency words into a foreign language, and
wherein the metadata includes the subset of high frequency words translated into the foreign language.
